(19) United States
(12) Patent Application Publication
(10) Pub. No.: US 2006/0149663 A1
(43) Pub. Date: Jul. 6, 2006

(54) Mortgage financing system

(76) Inventor: Evelyn Nichols, Seattle, WA (US)

Correspondence Address: David M Ostfeld;Adams and Reese, 4400 One Houston Center, 1221 Mckinney, Houston, TX, 77010, US

(21) Appl. No.: 10/561,661

(22) PCT Filed: Jun. 17, 2004
(86) PCT No.: PCT/US04/19272

§ 371 Date: Dec. 16, 2005

(30) Foreign Application Priority Data
Jun. 18, 2003 (US) PCT03 19093

(51) Int. Cl. G06Q 40/00

(52) U.S. Cl. 705/38

(57) ABSTRACT

The present invention is a method for providing mortgage financing to a borrower while additionally creating the opportunity for the borrower to invest in their long and short-term financial security. In real estate purchase, a mortgage is extended for greater than the real estate purchase price. The surplus amount is applied against at least one investment vehicle, so that after the periodic payments are completed, the borrower has equity in real estate and an interest in at least one investment vehicle. The investment vehicle provides security for the mortgage.

### TECHNICAL FIELD

The present invention relates generally to loan and mortgage financing. More specifically, a method for providing mortgage financing to a borrower while additionally creating the opportunity for the borrower to invest in a range of investment vehicles is disclosed.

### BACKGROUND OF THE INVENTION

The present invention is a method for providing mortgage financing to a borrower while additionally creating the opportunity for the borrower to invest in their long and short-term financial security.

There are a number of traditional mortgage systems. For example, in a Fixed Rate Mortgage Program, a borrower repays the amount of the mortgage loan in monthly mortgage payments for the term of the loan. Since the borrower's monthly mortgage payments are fixed, the borrower can expect to make the same monthly payment for the entire term of the loan.

In an Adjustable Rate Mortgage, the mortgage loan has a “low” starting interest rate. The “low” starting interest rate is used to calculate the mortgage payment for a specified period of time. Once the specified period of time is over, the interest rate is adjusted. The interest rate is adjusted by adding a set margin, which is determined by the lender, to an interest rate selected from any one of a variety of interest-rate indexes.

Some companies have implemented a system wherein a potential borrower receives a mortgage loan equaling 100% of the real estate cost. However, these 100% mortgage loans often involve a number of restrictions, thereby precluding potential borrowers from qualifying for the 100% mortgage loan. Potential borrowers may be required to meet certain requirements in order to qualify for the 100% mortgage loan, including having an income lower than a certain set amount, working in a specific profession, or living within a certain distance of a city or town, or served in the armed service.

England has implemented a system called a Modified Endowment Mortgage. The focus of this system is to pay off the borrower's mortgage at the end of the loan term. During the term of the loan, the borrower pays the interest only accruing on the mortgage. Any payment that would have been applied to the mortgage principal is instead funneled into a vehicle earning interest. The idea is that the vehicle earning interest will accumulate enough money by the end of the loan term to pay off the entire principal amount of the mortgage. However, if the interest rates are lowered during the loan term, the vehicle earning interest may not accrue enough money to fully pay the principal amount of the mortgage at the end of the loan term. If this occurs, the homeowner must funnel additional money into the vehicle earning interest in order to pay off the mortgage principal at the end of the loan term.

American companies tried to implement an American version of England's Modified Endowment Mortgage system. However, the American version of the Modified Endowment Mortgage system may be considered prohibitive because U.S. tax laws vary from English tax laws. Under U.S. tax laws, the English Modified Endowment Mortgage system may be considered “double-dipping,” meaning that borrower's gain tax write-offs for both their monthly interest payment and for interest accruing from the vehicle earning interest. Because “double-dipping” may violate U.S. tax laws, the American version of the English Modified Endowment Mortgage system has not been widely marketed.

### SUMMARY OF THE INVENTION

The present invention is a method for providing mortgage financing to a borrower while additionally creating the opportunity for the borrower to invest in their long and short-term financial security.

The method of the present invention creates financially healthy borrowers while reducing the risk of today's mortgage lending practices. Additionally, the method of the present invention supplements and builds a savings for borrower.

The method of the present invention provides for a collateral investment in an investment vehicle by having a loan amount approved for a principal amount and an investment amount, providing the principal amount to a seller of real estate on behalf of the borrow to pay to a seller and applying the investment amount to purchase one or more investment vehicles, making periodic payments towards the loan amount, and thereby concurrently accumulating equity in the real estate and an interest in the investment vehicles. Advantageously, the system may be administered by a system practitioner who may also act as a lender. Further, the loan may be forwarded to an escrow agent, who, upon transfer of the real estate, forwards the funds for the purchase of the real estate to the to the seller on behalf of the borrower and the remainder to an Investment Entity for the purchase of Investment Vehicles.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a table, by way of example, the structure of the mortgage financing system of the present invention (The Mana Loan™).

FIG. 2 is a flow chart showing the process, by way of example, of a mortgage and life policy application according to the present invention.

FIG. 3 is a table, which compares, by way of example, the mortgage financing system of the present invention (The Mana Loan™ System) with a standard mortgage.

FIG. 4 is a graph, which compares, by way of example, the performance of the present invention with a standard borrower.

FIG. 5 is a table, which compares, by way of example, the performance of the present invention with a standard mortgage both and bank mortgage investors.

FIG. 6 is a table summary, which compares, by way of example, the performance of the present invention when allowing the homeowner to skip mortgage payments to the present invention.

FIG. 6 is a table summary, which compares, by way of example, the performance of the present invention when allowing the homeowner to skip mortgage payments to the present invention.

FIG. 7 is an example of a loan schedule with a principal amount of $275,000 according to the present invention.

FIG. 8 is a table of an example of loan data with a principal amount of $ 55,000 according to the present invention.

FIG. 9 is an example of a loan schedule with a principal amount of $65,685 according to the present invention.

FIG. 10 is a table of an example of loan data with a principal amount $ 58,000 according to the present invention.

FIG. 11 is an example of a loan schedule with a principal amount of $ 275,000 according to the present invention.

FIG. 12 is a table of an example of loan data with a principal amount of $ 55,000 according to the present invention.

FIG. 13 illustrates a life insurance policy.

FIG. 14 illustrates a life insurance policy.

FIG. 15 illustrates a life insurance policy.

FIG. 16 illustrates a life insurance policy.

FIG. 17 illustrates a life insurance policy.

FIG. 18 illustrates a life insurance policy.

FIG. 19 illustrates a life insurance policy.

FIG. 20 describes the Framework of the Mana Loan Amortizer.

FIG. 21 is a schematic diagram of the Mana Loan Amortizer enabling amortization schedule's of the present invention.

FIG. 22 is the instructions of use of the Mana Loan Amortizer.

### BEST MODE(S) FOR CARRYING OUT THE INVENTION

The present invention is a method for providing mortgage financing to a borrower while additionally creating the opportunity for the borrower to invest in their long and short-term financial security. The borrower is also assisted in building financial strength to meet unforeseen influences such as illness, loss of job, or market trends that could threaten the loss of their home.

In the present invention, a potential borrower identifies real estate that the potential borrower would like to purchase. The potential borrower then applies for a mortgage loan from an entity employing the principles of the present invention. The entity employing the principles of the present invention may be a company, an individual, a bank, a mortgage company, a lender, an originator of mortgage loans, or a mortgage investor (hereinafter referred to as “System Practitioner”).

In applying for a mortgage loan from a System Practitioner, the potential borrower fills out a mortgage loan application. The mortgage loan application may be structured as a traditional mortgage loan application commonly known and used in the mortgage industry. As will be further discussed below, depending on how the potential borrower would like to invest in their long or short-term financial security (“Investment Vehicles”), a potential borrower may also fill out other types of applications. For example, if a potential borrower would like to purchase a life-insurance policy as an Investment Vehicle, the borrower may be required to fill out a life-insurance application. The life-insurance application would be one commonly known and used in the insurance industry.

If the potential borrowers mortgage loan application is approved, funds to cover both the cost of the real estate and the cost of the Investment Vehicles may be provided (“mortgage loan principal amount”). Standards for determining whether a mortgage loan application is approved, may be determined by the System Practitioner or by systems or methods commonly used in the mortgage industry. For example, a System Practitioner may require a credit report, a personal history report of the borrower, or a physical examination of the borrower.

For purposes of the present invention, funds provided to the potential borrower may vary based on the cost of the real estate, the cost of the Investment Vehicles, the potential borrower's financial situation, types of Investment Vehicles, or optional down payment provided by the potential borrower.

In one preferred embodiment, the System Practitioner may provide the funds to cover the mortgage loan principal amount. If the System Practitioner is the entity providing the funds, then the System Practitioner will forward the funds to an escrow practitioner or other similar company (collectively referred to as “escrow practitioner”). In another preferred embodiment, the System Practitioner may work through a bank or other lender (collectively referred to as “Lenders”) to secure the funds to cover the mortgage loan principal amount. If the Lender is the entity providing the funds, then the Lender will forward the funds to the escrow practitioner.

The day that a real estate transaction is finalized, thereby transferring the real estate from the seller of the real estate to the borrower, is commonly referred to in the real estate industry as the “escrow closing” day. On the day of escrow closing, the principal amount of the real estate is forwarded by the escrow practitioner to the seller on behalf of the borrower of the real estate for payment of the principal amount of the real estate. The remaining funds held by the escrow practitioner are forwarded to a pre-determined entity or entities to purchase the Investment Vehicles.

The Investment Vehicles are purchased in the name of the borrower and are held by the entity funding the mortgage loan principal amount, which may be either the System Practitioner or the Lender. The System Practitioner or Lender holds the Investment Vehicles as collateral. Examples of the various Investment Vehicles that may be purchased in the name of the borrower, either singularly or in combinations, include:
Annuities
Single Premium Immediate Annuities
Universal Life Policies
Certificates of Deposit
Guaranteed Interest Contracts
Mutual Funds
Savings Accounts
Zero Coupon Bonds
Municipal Bonds
Variable Life Policies
Whole Life Policies.
Any other investment whereby a borrower may invest in their long-term or short-term financial security.

During the loan term, which is a specified period of time that may be set by the borrower, System Practitioner, or Lender, the borrower provides mortgage payments to the entity funding the mortgage loan, which may be either the System Practitioner or the Lender. The mortgage loan payments submitted by the borrower pay both the mortgage loan principal amount and the interest accruing on the mortgage loan principal amount.

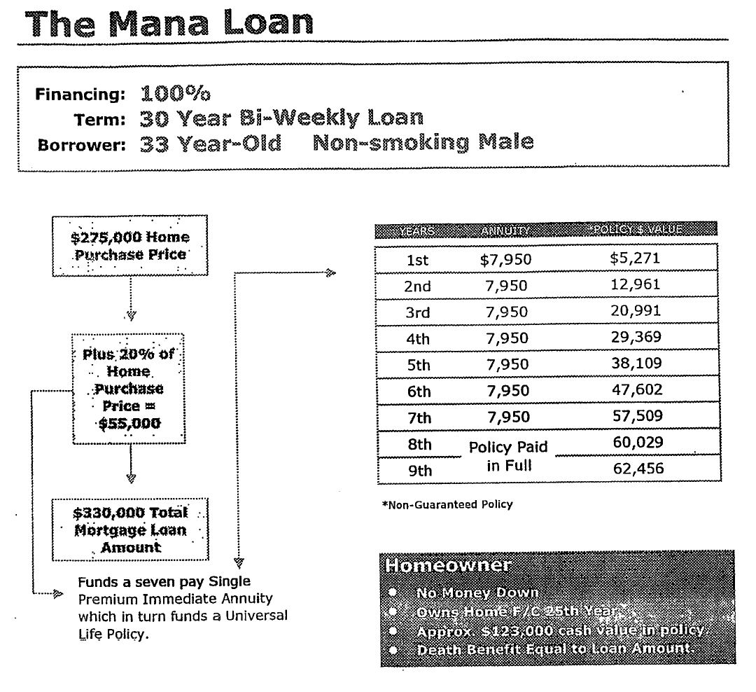

FIG. 1 is a chart, by the way of example, the structure of the mortgage financing system of the present invention (The Mana Loan System). Specifically, FIG. 1 shows the use of the mortgage loan to purchase an annuity, which in turn pays the premiums of an insurance policy.

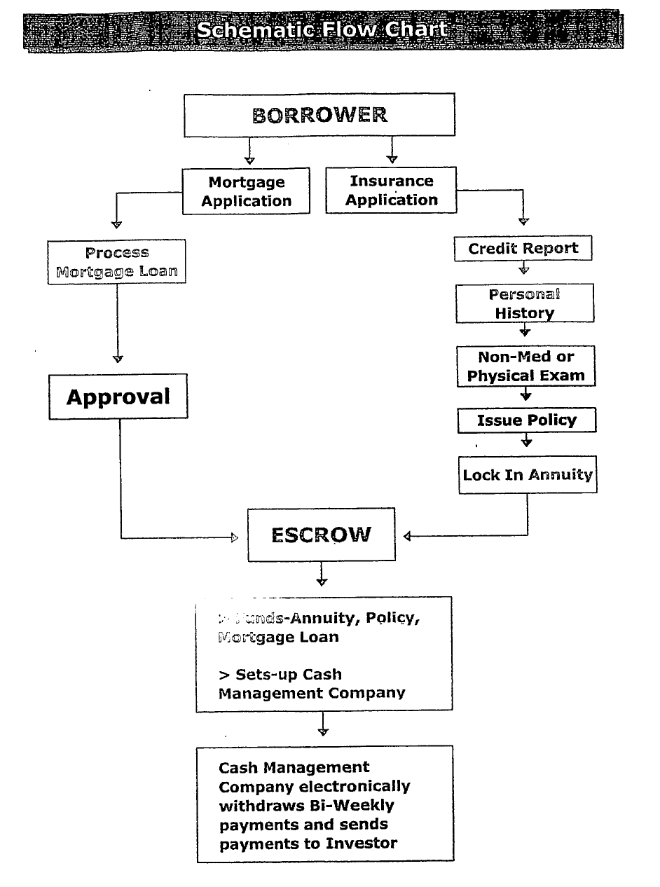

FIG. 2 is a schematic flow chart, by way of example, of the mortgage financing system according to the present invention. FIG. 2 is a flow chart, showing the process, by way of example, of a mortgage and life policy application according to the present invention. A mortgage and insurance application is taken from the homeowner and then is processed by normal standards of each industry. In the example of the mortgage loan, credit history and employment history are verified along with an appraisal of the home. Once all of the underwriting guidelines have been met, approval will be given and escrow will be given the instructions to proceed with closing. In the example of the completion of the Insurance application, a credit check will be ordered along with a personal health history and non-med physical exam. Once all criteria has been met an insurance policy will be issued. After both mortgage and insurance application have been approved the annuity yield will be locked in. The mortgage loan, annuity and policy will be funded at close of escrow.

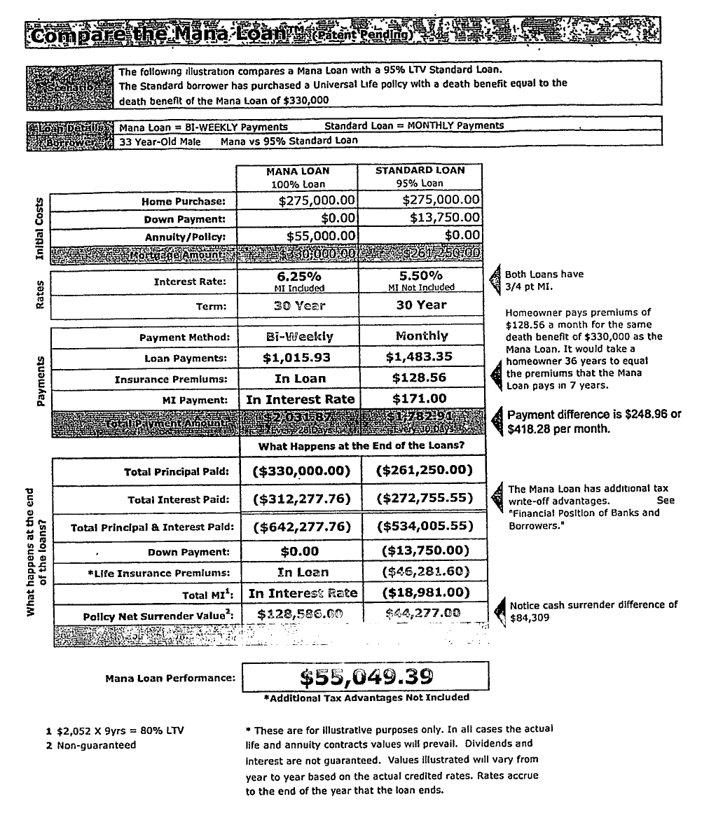

FIG. 3 is a table, which compares and the performance, by way of example, the mortgage financing system of the present invention (The Mana Loan System) with a standard loan.

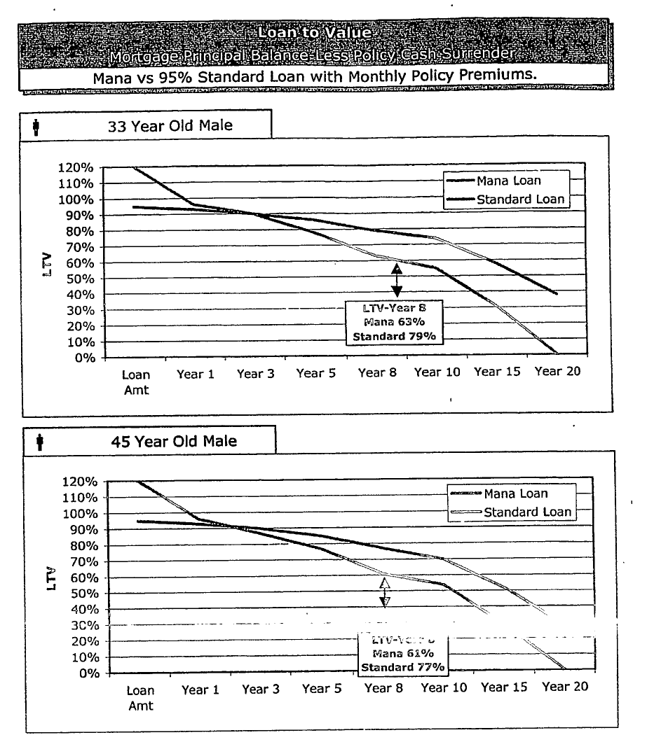

FIG. 4 is a graph, which compares, by way of example, the performance of the present invention of the Mana Loan mortgage with a standard borrower mortgage.

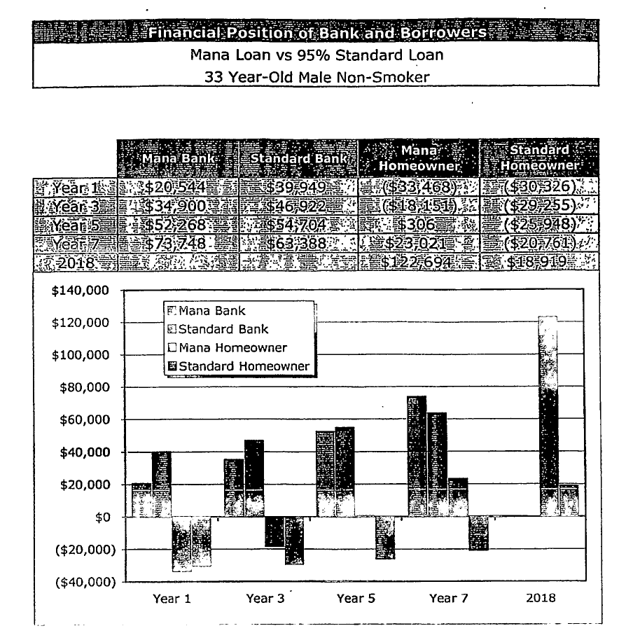

FIG. 5 is a table, which compares, by the way of example, the performance of the present invention for the following: A bank that holds the Mana Loan mortgage; a bank that holds the standard loan mortgage, a homeowner that holds a Mana Loan mortgage and a homeowner that holds a standard mortgage.

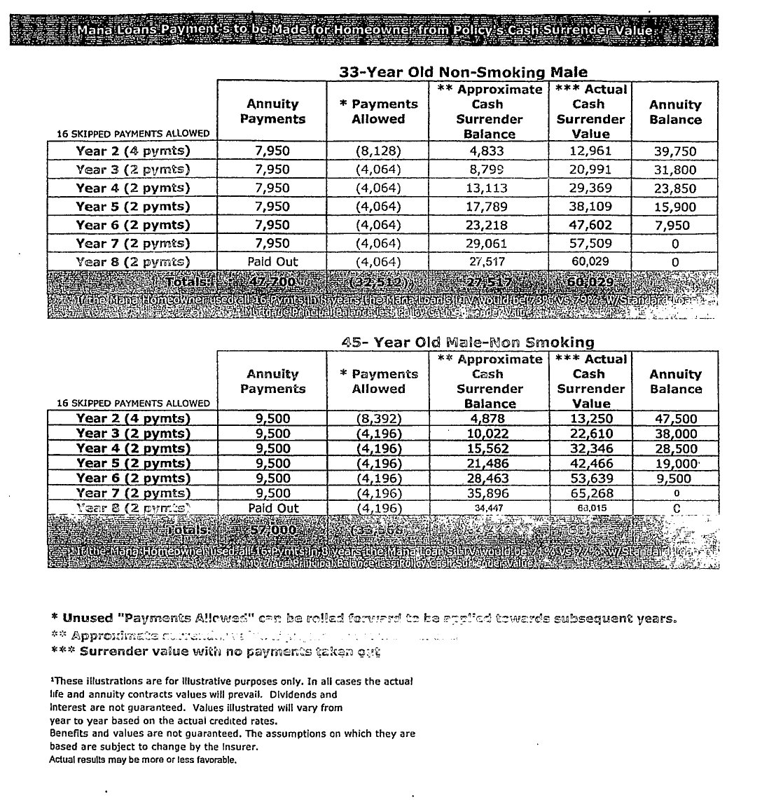

FIG. 6 is a table, which compares, by way of example, the performance of the present invention when allowing the Mana Loan homeowner to skip sixteen mortgage payments to the present invention.

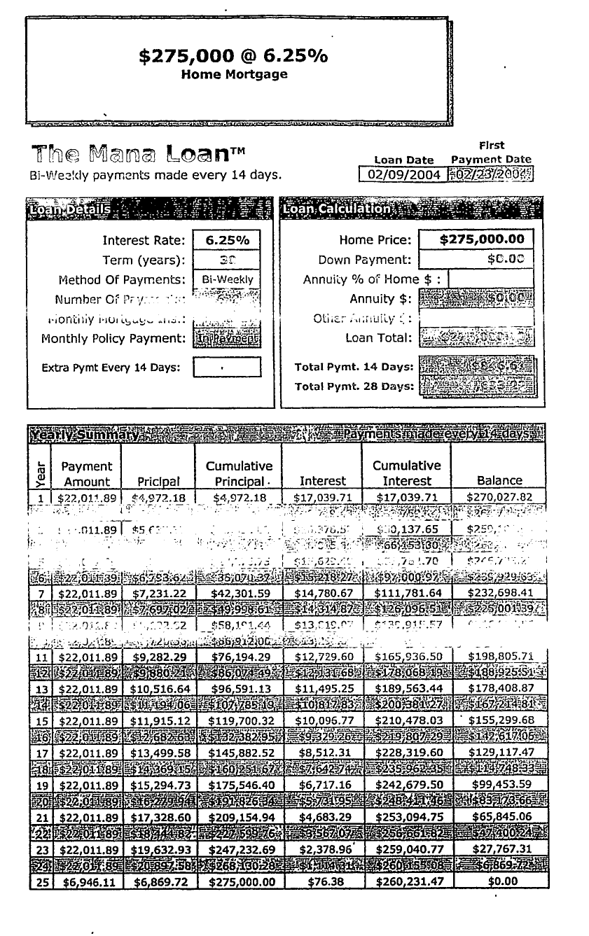

FIG. 7 is a thirty-year loan amortization schedule of $275,000 @ 6.25% example according to present invention.

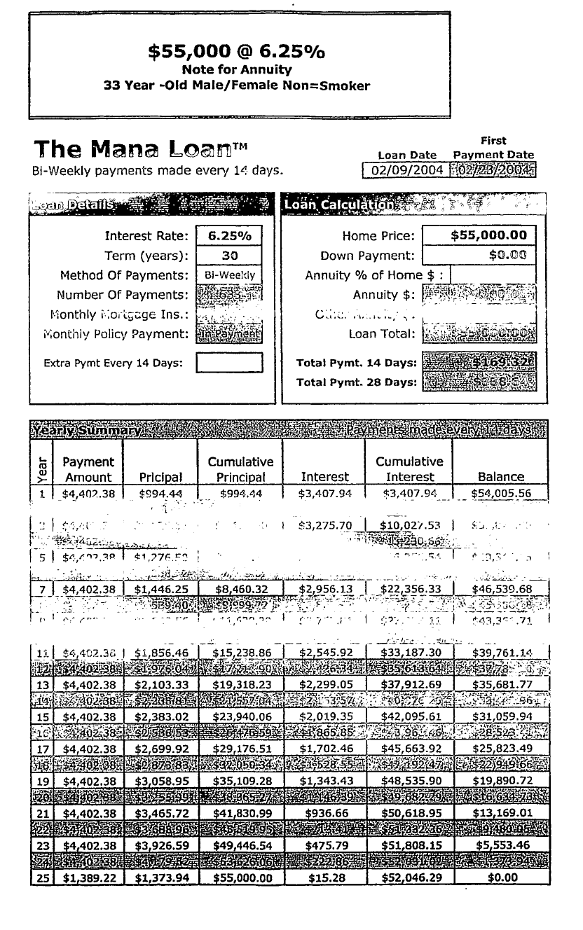

FIG. 8 is a thirty-year loan amortization schedule of $55,000 @ 6.25% example according to present invention for a 33 year-old male and female.

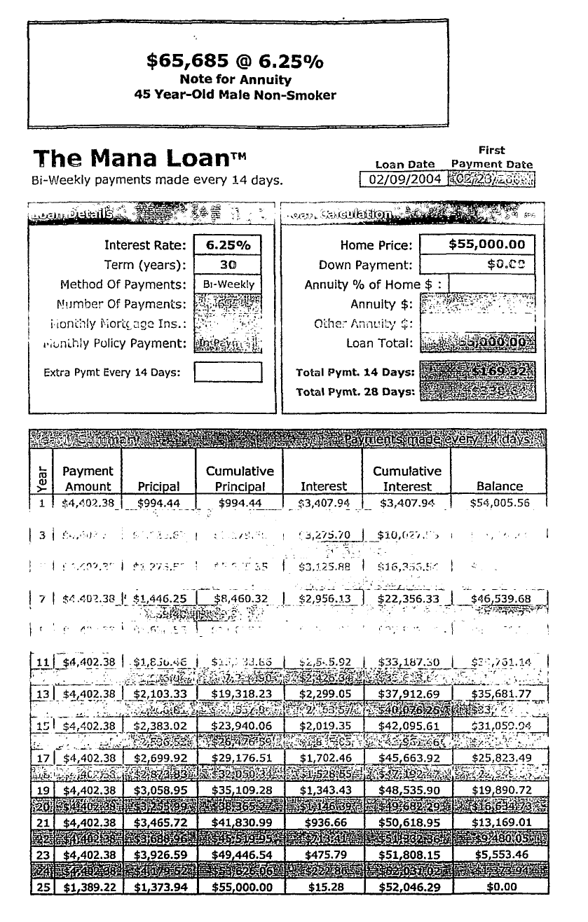

FIG. 9 is a thirty-year loan amortization schedule of $65,000 @ 6.25% example according to present invention for a forty-five year old male.

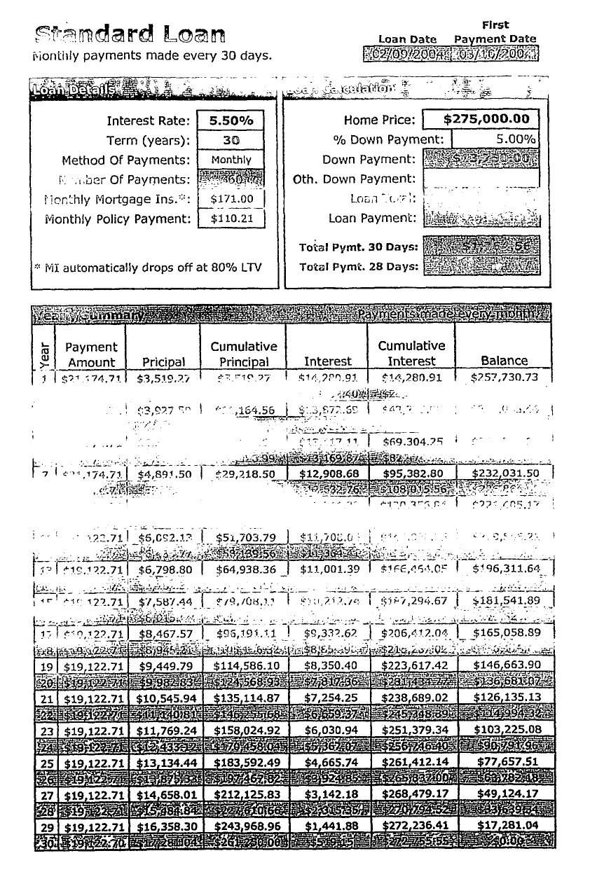

FIG. 10 is a thirty-year loan amortization schedule of $58,000 @ 6.25% example according to present invention for a forty-five year old female.

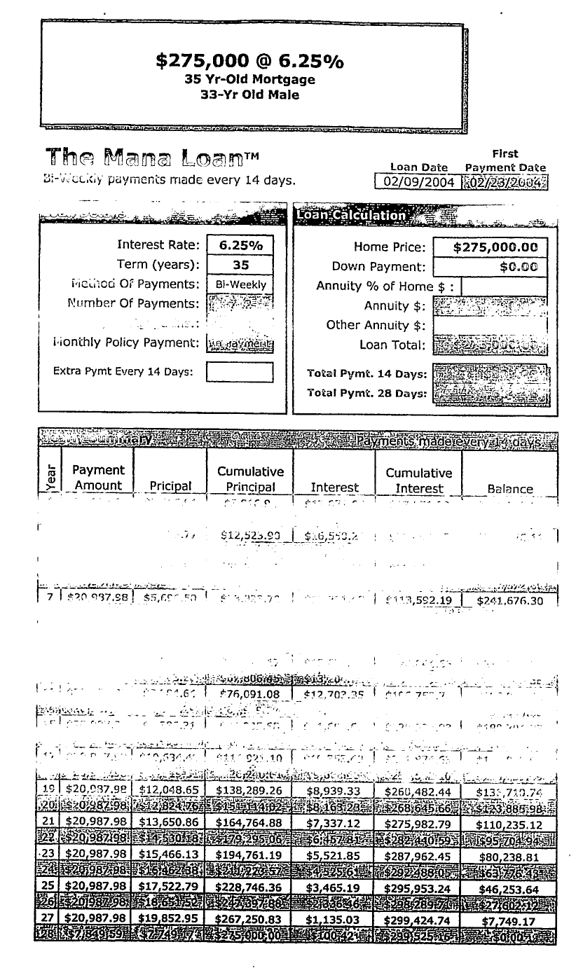

FIG. 11 is a thirty-five-year loan amortization schedule of $275,000 @ 6.25% example according to present invention.

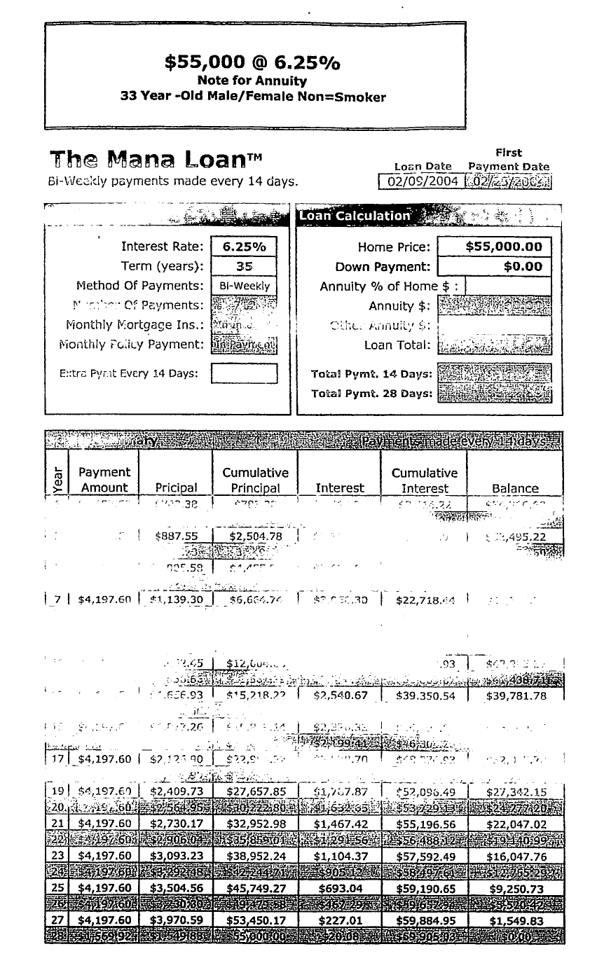

FIG. 12 is a thirty-five year loan amortization schedule of $55,000 @ 6.25% example according to present invention for a thirty-three year old male and female.

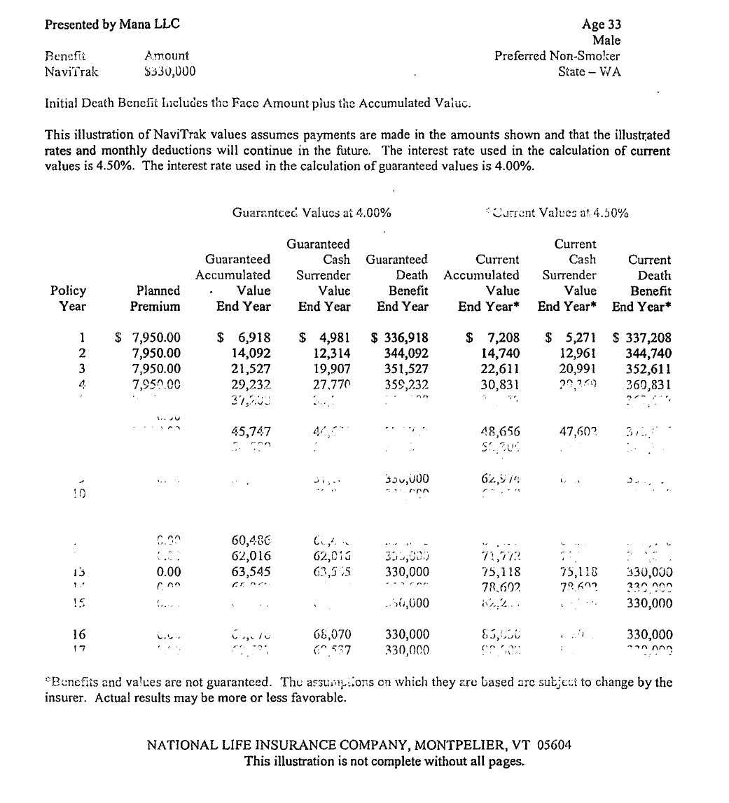

FIG. 13 illustrates a life policy for a 33 year-old male according to present invention.

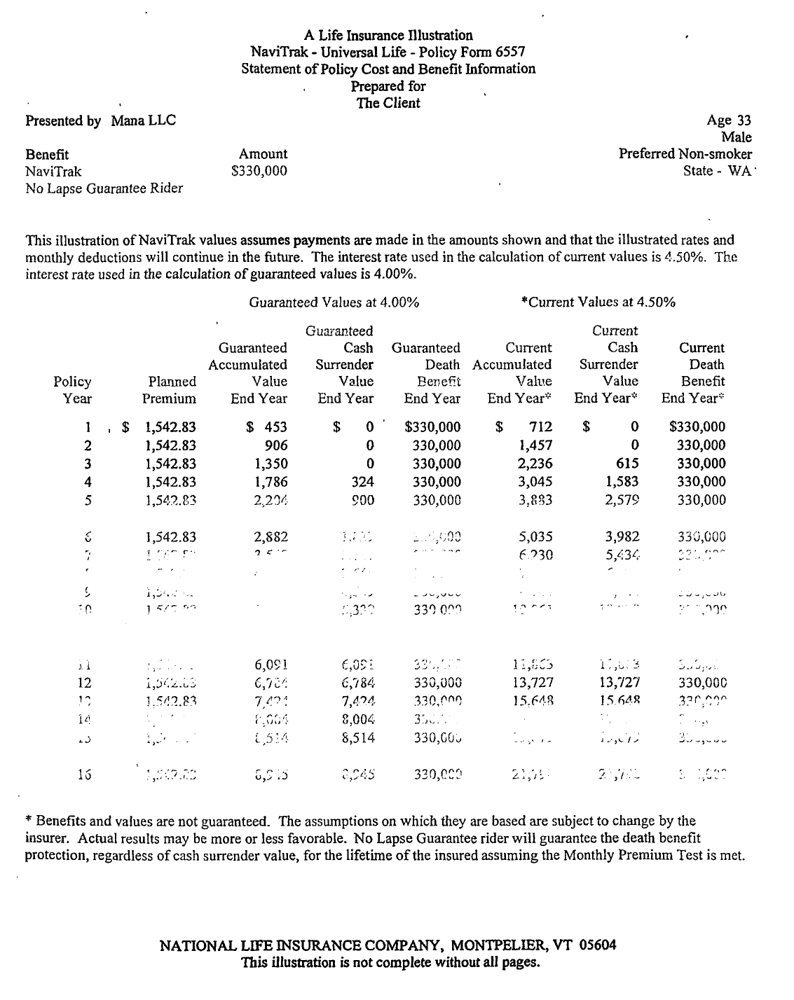

FIG. 14 illustrates a life policy for a 33 year-old male with standard loan.

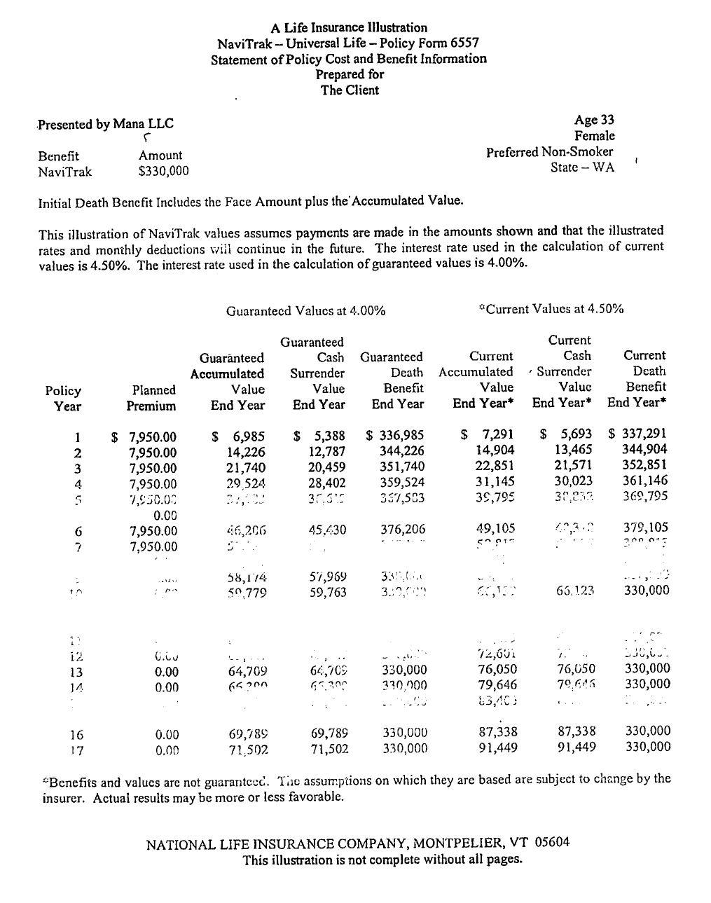

FIG. 15 illustrates a life policy for a 33 year-old female according to present invention.

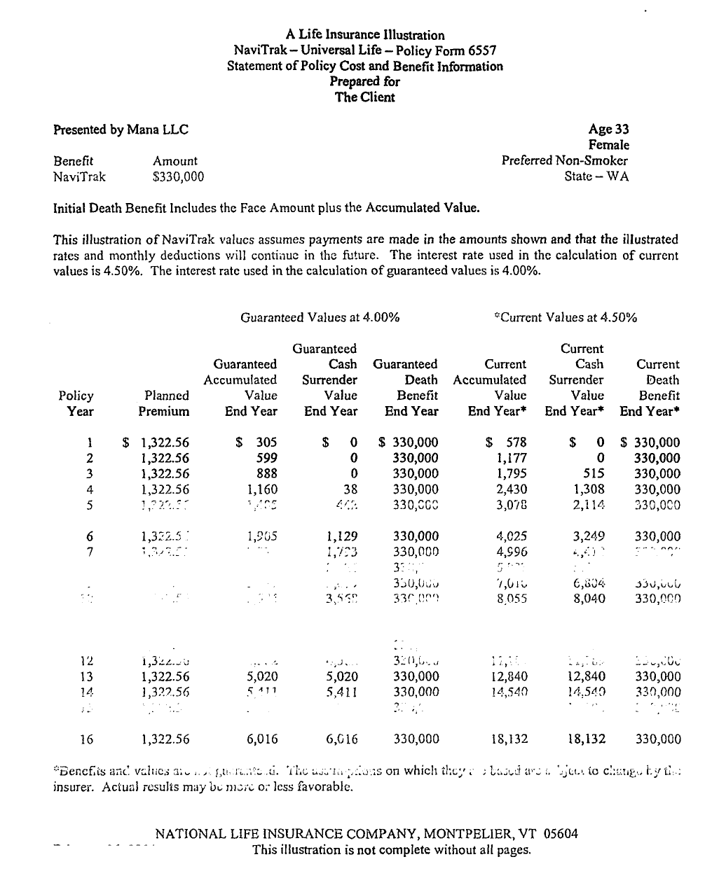

FIG. 16 illustrates a life policy for a 33 year-old female with standard loan.

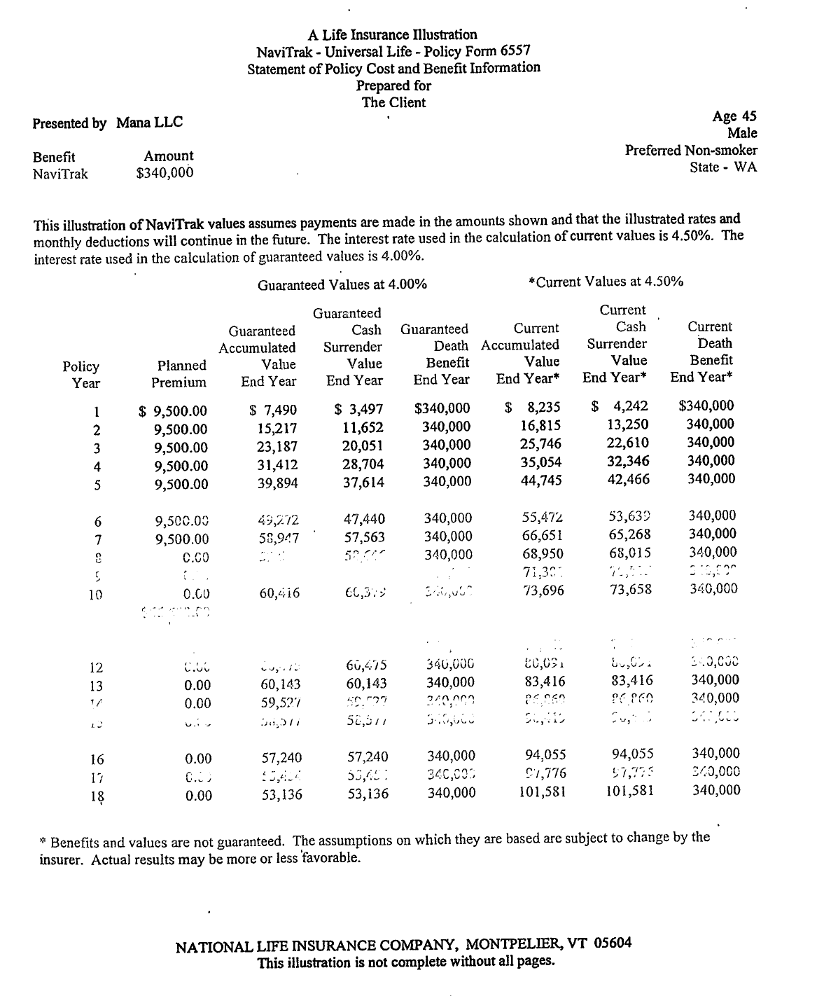

FIG. 17 illustrates a life policy for a 45 year-old male with standard loan.

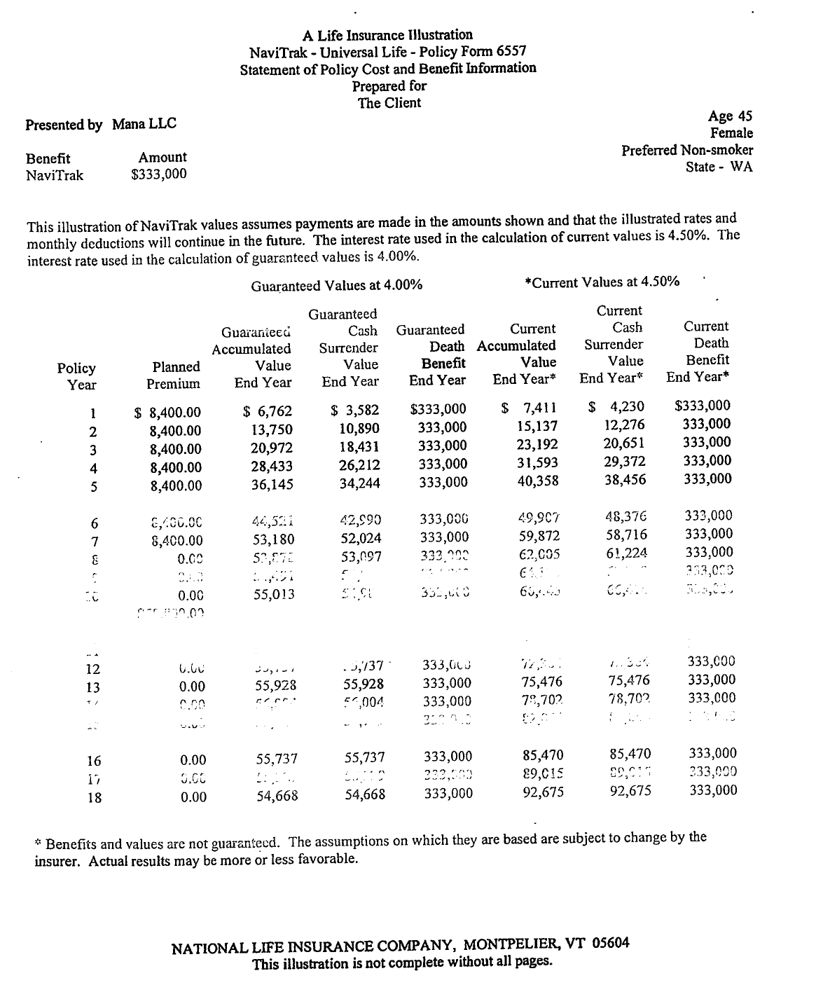

FIG. 18 illustrates a life policy for a 45 year-old female according to present invention.

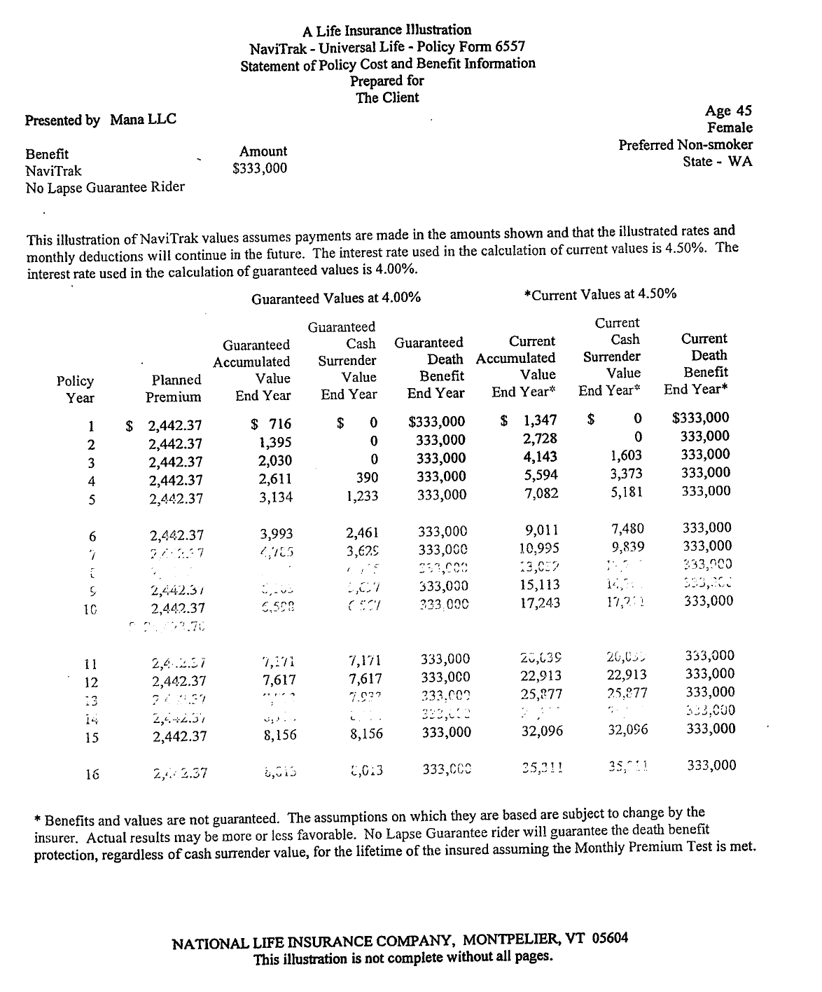

FIG. 19 illustrates a life policy for a 45 year-old female with standard loan.

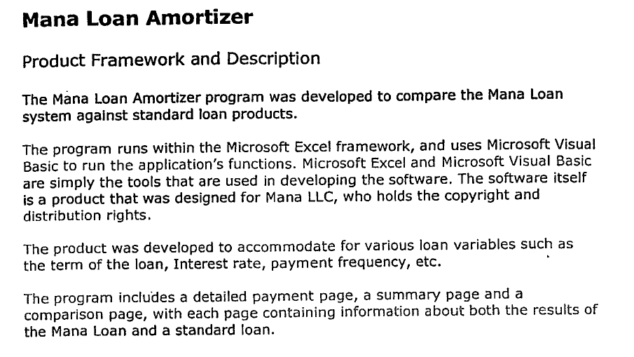

FIG. 20. The Mana Loan Amortizer program was developed to compare the Mana Loan system against standard loan products. The program runs within the Microsoft Excel framework, and uses Microsoft Visual Basic to run the application's functions. Microsoft Excel and Microsoft Visual Basic are simply the tools that are used in developing the software.

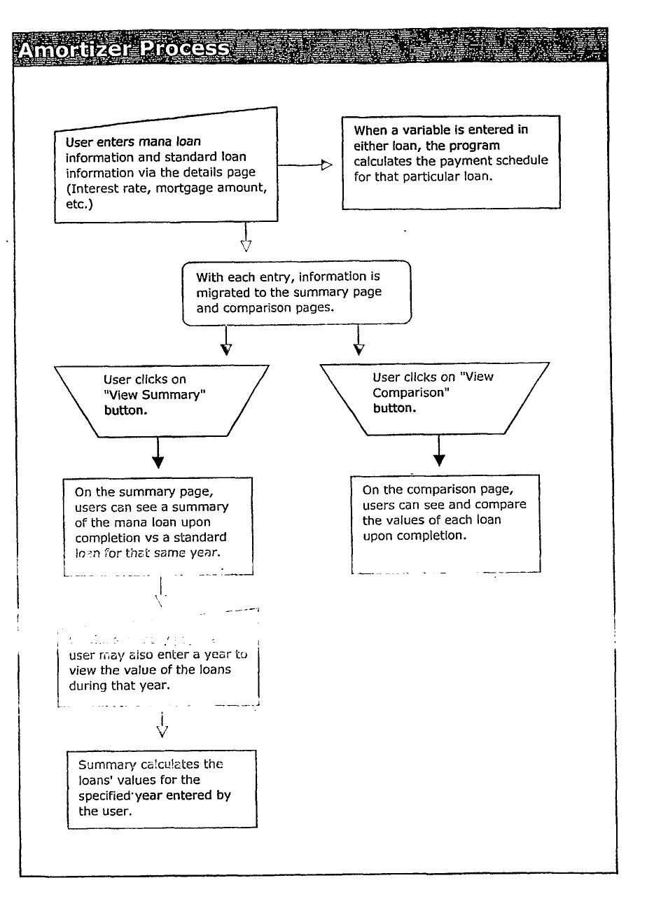

FIG. 21 is a schematic diagram of the Mana Loan Amortizer enabling amortization comparison's with a standard loan.

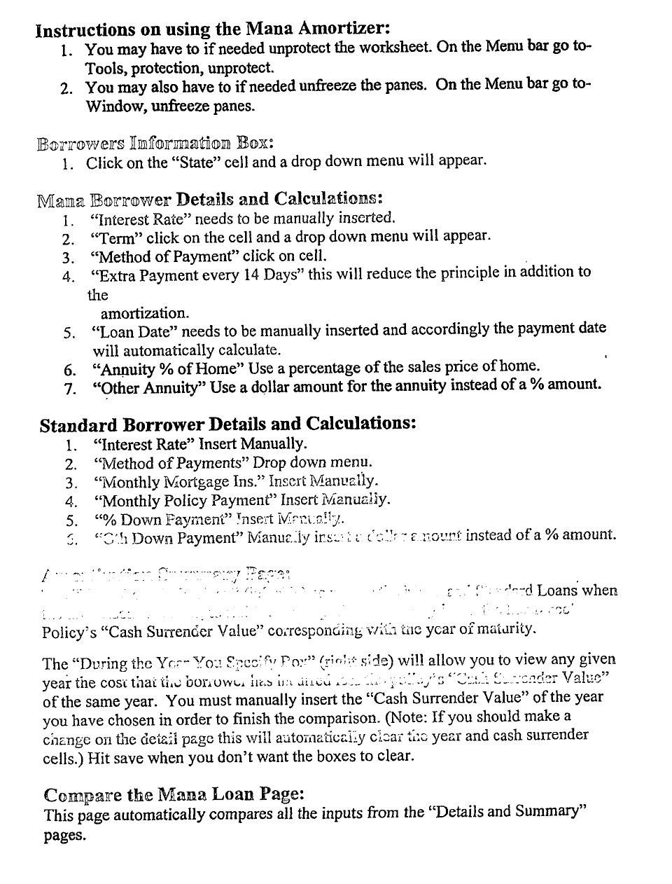

FIG. 22 is by the way of example the instructions of how to use the Mana Loan Amortizer as discussed above and shown in FIG. 20.

Instructions on Using the Mana Amortizer
1. You may have to if needed unprotect the worksheet. On the Menu bar go to-Tools, protection, unprotect.
2. You may also have to if needed unfreeze the panes. On the Menu bar go to-Window, unfreeze panes.

Borrowers Information Box:
1. Click on the “State” cell and a drop down menu will appear.

Mana Borrower Details and Calculations:
1. “Interest Rate” needs to be manually inserted.
2. “Term” click on the cell and a drop down menu will appear.
3. “Method of Payment” click on cell.
4. “Extra Payment every 14 Days” this will reduce the principle in addition to the amortization.
5. “Loan Date” needs to be manually inserted and accordingly the payment date will automatically calculate.
6. “Annuity % of Home” Use a percentage of the sales price of home.
7. “Other Annuity” Use a dollar amount for the annuity instead of a % amount.

Standard Borrower Details and Calculations:
1. “Interest Rate” Insert Manually.
2. “Method of Payments” Drop down menu.
3. “Monthly Mortgage Ins.” Insert Manually.
4. “Monthly Policy Payment” Insert Manually.
5. “% Down Payment” Insert Manually.
6. “Oth Down Payment” Manually insert a dollar amount instead of a % amount.

Amortization Summary Page:

The “Upon Completion Box” (left side) compares the Mana and Standard Loans when the Mana Loan matures, to finish the comparison manually insert the Insurance Policy's “Cash Surrender Value” corresponding with the year of maturity.

The “During the Year You Specify Box” (right side) will allow you to view any given year the cost that the borrower has incurred less the policy's “Cash Surrender Value” of the same year. You must manually insert the “Cash Surrender Value” of the year you have chosen in order to finish the comparison. (Note: If you should make a change on the detail page this will automatically clear the year and cash surrender cells.) Hit save when you don't want the boxes to clear.

Compare the Mana Loan Page:

This page automatically compares all the inputs from the “Details and Summary” pages.

Optimally, at the end of the loan term, the borrower has paid off the mortgage loan and is left with a fully paid Investment Vehicle and full ownership interest and rights in the real estate.

An example of one preferred embodiment of the present invention:
A potential borrower would like to purchase a piece of real estate valued at One Hundred and Seventy Thousand Dollar ($275,000.00).
The potential borrower fills out a mortgage loan application. Additionally, the potential borrower fills out a life insurance policy application with an insurance company. Both the life insurance policy application and mortgage loan application may be reviewed according to standards used in the insurance and mortgage industries.
If the life insurance policy application and mortgage loan application are approved, the System Practitioner funds the potential borrower with a mortgage loan principal amount equal to 120% of the purchase price. This would equal a mortgage loan principal amount totaling $275,000.00 (100% of purchase price)+$55,000 (20% of purchase price)=Three Hundred and Thirty Thousand Dollars. For purposes of this example, and as will be further discussed below, the borrower may also be, at this time, “locked in” to an annuity percentage rate according to standards employed in the insurance industry.
The funds for the mortgage loan principal amount are forwarded to an escrow practitioner. On the day of escrow closing, the escrow practitioner forwards to the insurance company funds totaling $55,000. In like manner, the escrow practitioner forwards funds totaling $275,000 to the seller of the real estate for payment of the principal amount of the real estate.
The insurance company takes the $55,000 and purchases, in the borrower's name, at least two Investment Vehicles.
Investment Vehicle No. 1 is an annual cash-bearing instrument. In this example, the annual cash-bearing instrument is a single premium immediate annuity. The single premium immediate annuity is purchased in the name of the borrower, with the $55,000 forwarded to the insurance company by the escrow practitioner. The single premium immediate annuity is preferably purchased on escrow closing day and has a percentage rate that was locked in after the borrower was approved for the mortgage loan principal amount and life insurance policy. The first annuity payment is provided the same day the single premium immediate annuity is purchased in the name of the borrower. The first annuity payment is then used to pay the first premium of the life insurance policy, which is further discussed below. Preferably, the annuity payments will be spread out over at least a 4-year period, with each annuity payment being used to pay the premiums of the life insurance policy.
Investment Vehicle No. 2 is a life insurance policy funded from the payments received from Investment Vehicle No. 1. In a preferred embodiment, the life insurance policy is fully paid in at least 7 years.
During the mortgage loan term, the borrower provides mortgage loan principal payments to the System Practitioner to pay off the mortgage loan. These payments are applied to both the mortgage loan principal (which in this example is $330,000) amount and the interest accumulating from the mortgage principal amount.
At the end of the mortgage loan term, the borrower will preferably have paid off the mortgage loan principal and the interest accumulated from the mortgage loan principal balance. The borrower will own, unencumbered, Investment Vehicle No. 2, which in this example, is a life insurance policy. This system may be beneficial to parties other than the borrowers who are involved in the transaction. For example, see the following bullet points:
Lender or System Practitioner's rights: The Investment Vehicles, while purchased in the name of the borrower, are held by the entity funding the mortgage loan principal amount, which may be either the System Practitioner or Lender. The System Practitioner or Lender has rights in the Investment Vehicles as collateral until the mortgage loan and the interest accumulated from the mortgage principal amount has been fully paid to the Lender or System Practitioner.
The benefits and industrial applicability of the mortgage system of the present invention, to the borrower, may include:
Fast equity build-up. The borrower may build equity in two ways. First, with the mortgage payments reducing the mortgage principal balance, and second, with the yield of the Investment Vehicles.
In a preferred embodiment, a bi-weekly mortgage payment schedule is utilized. A bi-weekly mortgage loan payment schedule provides more payments against the mortgage loan balance than a monthly mortgage loan payment schedule; thereby reducing the mortgage loan principal more rapidly than if a monthly mortgage loan payment is used.
Investment Vehicles may be transferred from real estate to real estate as collateral.
Investment Vehicles may be able to cover any shortfalls if the borrower sells the real estate.
Preferably, if private mortgage insurance is used, the private mortgage insurance is lender-based private mortgage insurance that is worked into the mortgage loan. Lender-based private mortgage insurance may save the borrower money in non-tax deductible dollars.
If an emergency occurs and the borrower is unable to maintain the mortgage loan payment schedule, the entity funding the mortgage loan principal amount, which may be either the Lender or System Practitioner may withdraw (from the Investment Vehicles in order to maintain mortgage payments and avoid forfeiture of the real estate.
The borrower may increase the amount of money placed into Investment Vehicles, which may accelerate the growth of the Investment Vehicles and may allow the borrower to pay off the mortgage loan at an earlier date.
No down payment is required.
An early pay-out option. Rapid reduction of the loan through bi-weekly payments, plus the growth of the insurance policy's cash value, gives the borrower the option to pay off the mortgage balance earlier.

The benefits of the mortgage system of the present invention, to the System Practitioner may include:
Higher yields over Standard “Prime” paper.
The mortgage financing system of the present invention does not affect the already secured portfolios of borrowers.
Investment Vehicles are used as collateral and therefore, exposure to risks such as forfeiture, property devaluation (depreciation), or borrowers being unable to pay mortgage loan payments is reduced.
If a bi-weekly payment plan is used, the cumulative effects of the bi-weekly payments rapidly reduce the mortgage loan, plus the growth of Investment Vehicles build up equity at an accelerated rate.
In case of a temporary interruption of income from the borrower, the entity funding the mortgage loan principal amount, which may be either the Lender or System Practitioner, has a secure source of income from Investment Vehicles in order to receive mortgage loan payments The entity funding the mortgage loan principal amount, which may be either the Lender or System Practitioner, has rights in the Investment Vehicles held as collateral.
The borrower will likely do repeat business with the System Practitioner since the borrower may transfer Investment Vehicles as collateral for the borrower's next real estate purchase

The benefits of the mortgage system of the present invention, to the mortgage investor or Lender may include:
Higher yields over Standard “Prime” paper (potentially 75 to 100 basis points)Standard.
Increased loan volume. The present invention is likely to attract new borrowers, from the first time homebuyers to high-income professionals with 660+ credit scores, financial plans, and solid performing investments that do not want to interrupt their portfolios to purchase a home.
Additional security. The use of Investment Vehicles such as an annuity and insurance policy as collateral reduces the risk exposure to the Lender.
Faster equity build-up and reduced risk. The cumulative effects of the bi-weekly payments rapidly reducing the mortgage principal balance and the growth of the insurance policy cash value builds up equity at an accelerated rate. The loan according to the present invention reaches 60% loan to value by the eighth year.
Protection payment interruption. In case of a temporary interruption of income from the borrower or homeowner, the mortgage investor or Lender has a secure source of funds from the insurance policy or other Investment Vehicles to continue mortgage payments.
Life-long borrowers are generated. The Lender or mortgage investor will have the borrower or homeowner as a client whom will do repeat business by transferring their insurance policy or other Investment Vehicles as collateral for their next home purchase.
The benefits of the mortgage system of the present invention, in creating 15 cross-selling opportunities, may include:
Increased policy sales. Adding a waiver of premiums and any number of various riders augments the attraction of the present invention.
Longer persistency ratios. Because the policy is paid in full up front, the policy's persistence ratio increases, which in turn creates higher revenue.
Financial planning opportunities. The present invention creates the atmosphere for cross-selling opportunities such as municipal bonds, mutual funds, certificates of deposits, annuities, additional personal loans and other opportunities.
Developing total financial planning opportunities. The present invention creates the opportunity to assist the borrower or homeowner in reaching personal financial goals.

The Mana Loan™ can be utilized with loans that have no collateral, or loans that require a down payment. Having collateral or requiring a down payment may or may not lower the interest rate. Also, the Mana Loan can be structured with airplanes, boats, large construction and farming equipment. In other words, any type of collateralized loan that normally requires a down payment.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A method for providing mortgage financing to a borrower comprising:
a. identifying real estate;
b. applying for mortgage loan;
c. having said mortgage loan application approved;
d. receiving a mortgage loan principal amount to cover cost of said real estate and at least one investment vehicle;
e. forwarding funds equivalent to said cost of said real estate from said mortgage loan principal amount to said seller;
f. purchasing at least one investment vehicle with funds from said mortgage loan principal amount;
g. providing mortgage payments; and
h. having ownership interest in said at least one investment vehicle and said real estate.

2. The method of claim 1, wherein said mortgage payments are for a loan term.

3. The method of claim 1 further comprising the step of holding said at least one investment vehicle as collateral against said mortgage loan prior to vesting full ownership rights as part of step (h).

4. The method of claim 3 wherein said collateral is held by a lender.

5. The method of claim 4 wherein said lender is a system practitioner.

6. The method of claim 3 further comprising the step of making periodic payments against said mortgage loan.

7. The method of claim 6 wherein when unable to make said periodic payments, funds are applied from said at least one investment vehicle to said mortgage loan equal to said periodic payment.

8. A method of implementing a loan repayment plan, which comprises:
a. Determining a principal loan amount to be provided to a borrower;
b. Determining an additional loan amount to be provided to a borrower;
c Determining a repayment term;
d. Providing said principal amount;
e. Providing said additional loan amount to an investment entity;
f. Purchasing at least one investment vehicle with funds from said additional loan amount;
g. Providing loan repayment increments during said repayment term; and
h. Perceiving an interest in said at least one investment.

9. The method of claim 8 wherein said loan is a real estate mortgage.

10. The method of claim 9 wherein a lender supplies said principal loan amount and said additional loan amount.

11. The method of claim 10 wherein said lender takes an interest in said at least one investment vehicle as collateral against said real estate mortgage.

12. The method of claim 10 comprising the step of a system practitioner collecting application criteria from a borrower prior to step (c).

13. The method of claim 12 further comprising the step of said system practitioner providing said principal loan and said additional loan amount to an escrow entity prior to step (f).

14. The method of claim 13 further comprising the step of said escrow entity providing said loan amount to a seller and said additional loan amount to said investment entity.

15. The method of claim 14 wherein said investment entity is said system practitioner.

16. The method of claim 14 wherein said investment entity is a financial institution.

17. The method of claim 8 wherein said investment vehicle is at least one of: an annuity;
a single premium immediate annuity; a universal life policy; a certificate of deposit; a guaranteed interest contract; a mutual fund; a savings account; a zero coupon bond; a municipal bond; a variable life policy; a whole life policy; a financial security investment.

18. The method of claim 8 wherein said additional loan amount is substantially 20 percent of said principal loan amount.

19. A method of mortgaging real estate which provides for a collateral investment in an investment vehicle comprised substantially of the steps of having a loan amount approved for a principal amount and an investment amount; providing said principal amount to a seller of said real estate; applying said investment amount to purchase at least one investment vehicle; making periodic payments towards said loan amount, thereby concurrently accumulating equity in said real estate and an interest in said at least one investment vehicle.

20. The method of claim 19 further comprising a first and second investment vehicle, wherein said first investment vehicle is an annuity, and said second investment vehicle is an insurance policy.

21. The method of claim 19 further comprising the steps of purchasing said annuity, followed by applying said insurance policy, thereby providing security for said loan amount.
